(19) United States
(12) Patent Application Publication
(10) Pub. No.: US 2012/0130914 A1
(43) Pub. Date: May 24, 2012

(54) JURISDICTION COMPLIANCE ENGINES

(75) Inventors: Kelly KINGHORN, Calgary (CA); Ivo WILLEMS, Houston, TX (US)

(73) Assignee: FLUOR TECHNOLOGIES CORPORATION, Aliso Viejo, CA (US)

(21) Appl. No.: 13/287,778

(22) Filed: Nov. 2, 2011

Related U.S. Application Data
(60) Provisional application No. 61/416,398, filed on Nov. 23, 2010.

(51) Int. Cl. G06Q 99/00

(52) U.S. Cl. 705/317

(57) ABSTRACT

Jurisdiction compliance engines are presented. Contemplated jurisdiction compliance engines are design tool agonistic and can operate in conjunction with design tools to ensure instantiated construction objects comply with jurisdiction rules sets. The jurisdiction rules sets can include optimization criteria based on metrics that can govern how construction objects are integrated into a design project.

This application claims the benefit of priority to U.S. provisional patent application having Ser. No. 61/416398, filed on Nov. 23, 2010. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is construction project design technologies.

### BACKGROUND

Construction design engineers develop 3D models of constructions projects during a design phase of a construction project. The 3D model is used to generate one or more project deliverables needed to construct, operate and maintain the facility. Key deliverables include engineering drawings, material quantities, equipment specifications, training materials, or other items required by the client or a jurisdictional governing entity. As a design engineer develops a 3D model, the designer must ensure that the model adheres to one or more design practices required by the jurisdictional governing entity. The design practices can impact the actual design of the 3D model, as well as impacting engineering deliverables or other objects associated with a capital project. Typically design engineers manually check to determine if a 3D model complies or violates design practices. Such manual checks are performed after design steps have been taken, which can introduce delays in generating key deliverables because the design has not been properly validated a priori. A better approach would offer a real-time check to ensure a modeled design complies with a jurisdiction's design practices by instantiating construction objects for use by the design tools. Real-time feedback on compliance would ensure timely delivery of key engineering deliverables or decrease risk of noncompliance early in the life cycle of a construction project, thus eliminating costly redesigns to meet deliverable requirements. Furthermore, real-time feedback on compliance with multiple jurisdictional rules would also provide a design engineer opportunities for optimizing the design according to a purpose or intent of the jurisdictional requirements or at least make an informed decision about the priorities of the jurisdictional rules.

U.S. patent application publication 2002/0035408 to Smith titled “System and Process for Client-Driven Automated Computer-Aided Drafting”, filed Sep. 19, 2001, discusses identifying assets in a raw CAD drawing and applying compliance criteria for creating detailed engineering specifications. Smith seeks to extract assets from a CAD file then apply compliance criteria as opposed to automatically instantiating objects within a design tool according to jurisdiction rule sets.

U.S. patent application publication 2008/0059220 to Roth et al. titled “Building Plan Compliance System and Method”, filed Aug. 30, 2007, describes some effort toward ensuring a building plan complies with jurisdictional codes. However, the Roth approach merely provides a web-based compliance utility through which a user can submit a CAD file representing a building plan. The utility determines whether the building plan complies with naming conventions of a single set of jurisdictional codes after the building plan is complete. Roth also fails to appreciate that jurisdiction codes carry a purpose, which can give rise to optimization opportunities.

Although less relevant, still others have directed their efforts toward ensuring a business practice complies with one or more rules. For example, U.S. patent application publication to Bhatia et al. titled “Compliance Management Method and System, filed Mar. 9, 2007, discloses a system capable of ensuring a business practice is in compliance with different compliance domains. In addition, U.S. Pat. No. 7,496,552 to Huang titled “Method for Rule Compliance Situation Checking and Related Checking System”, filed Aug. 29, 2006, also focuses on ensuring business practices comply with rules. Unfortunately such approaches fail to take into account real-time compliance while building a modeled physical environment or indicate how to optimize a design based on jurisdictional compliance information.

Unless the context dictates the contrary, all ranges set forth herein should be interpreted as being inclusive of their endpoints and open-ended ranges should be interpreted to include commercially practical values. Similarly, all lists of values should be considered as inclusive of intermediate values unless the context indicates the contrary

The above art fails to provide for jurisdiction compliance engines that can automatically instantiate design & construction objects, including key engineering deliverables, that comply with jurisdictional rule sets or that optimize a construction project according to a purpose of the jurisdictional rules set. The following presented subject matter seeks to address these issues, among others.

Thus, there is still a need for jurisdiction compliance engines.

### SUMMARY OF THE INVENTION

The inventive subject matter provides apparatus, systems and methods in which one can utilize a jurisdiction compliance engine to identify opportunities for optimizing a project throughout a project life cycle from conception, design, through end-of-life. One aspect of the inventive subject matter includes a jurisdiction compliance engine. Contemplated compliance engines include one or more databases storing reusable assembly objects and storing jurisdiction rule sets. A reusable assembly object represents a construction object having properties, available contexts defining the object's appropriate use, or behaviors. Jurisdiction rule sets represent codified practices related to some aspect of a construction project usually under authority of a governing entity (e.g., city, state, country, standards body, construction firm, client first, affiliations, etc.). The jurisdiction compliance engine can further include one or more design tool interfaces through which the engine exchanges assembly information with a design tool. Each design tool interface can be adapted to communicate with a specific design tool. The engine can further include an assembly instantiation module that obtains assemblies from an assembly database and jurisdiction rule sets from a jurisdiction database, and that instructs the design tool, via a design tool interface, to instantiate a modeled construction object according to the design rules within the assembly and according to at least one of the jurisdiction rule sets.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of jurisdiction compliance engine environment.

FIG. 2 is an overview of a possible jurisdiction rule set structure.

FIG. 3 is illustrates various interplay among multiple jurisdiction rule sets with respect to a construction project context.

FIG. 4 is a qualitative chart illustrating relevance of various jurisdictions with respect life-cycle stages of a construction project.

### DETAILED DESCRIPTION

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that while the following description is drawn to a computer/server jurisdictional compliance system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing an integrated construction communication infrastructure among disparate design tools. A design tool agnostic jurisdictional compliance engine instructs various design tools to incorporated instantiated construction objects with various design tools over a network. Thus, the disclosed system provides a technical design or modeling infrastructure.

A jurisdiction compliance engine can be constructed to store jurisdiction rule sets from across many disparate jurisdictions where the jurisdiction compliance engine can create or instantiate assembly objects as construction objects that comply with the jurisdiction's rules or codes. Such a compilation of jurisdiction rule sets and assembly objects can be quite advantageous for companies working across geopolitical boundaries (e.g., city, state, country, region, etc.) or corporate affiliations (e.g., standards bodies, construction firm, client, etc.). When designing a facility, a design engineer can incorporate instantiated construction objects within a modeled design according the jurisdictional requirements regardless of the design tool being used. Furthermore, jurisdiction rule sets exist for a purpose, where compliance results in a measurable impact of a metric reflecting the purpose (e.g., safety, mean-time-between-failures, etc.). Such metrics provide an opportunity for optimization according the jurisdiction's purpose. In additional disparities or differences among jurisdictions give rise for optimizing a design by possibly tailoring instantiated objects according to relevant jurisdictions.

The disclosed techniques can co-exist with or otherwise augment an Intelligent Library Environment (ILE) providing access to construction assemblies as described in co-owned application having Ser. No. 13/233,311 entitled “Intelligent Plant Development Library Environment” filed Sep. 15, 2011. An ILE includes a library of assemblies, which are considered to represent complex objects as opposed to merely being a record of physical component geometry. An assembly can include an amalgam of information from many different engineering or design perspectives, which can include descriptive information about a construction component (e.g., bolt, welds, pipes, cabling, modules, processing units, etc.), a context describing an appropriate use of the assembly, behaviors of the assembly during use, or design rules. One should consider an assembly as representing a design-tool agnostic embodiment of a design practice relating to a construction object. One should also appreciate that assembly objects can related to non-construction components. Example non-construction can include project plan documents, schedules, bills of material, logistic plants, training materials, manuals, inspection plans, or other types of key engineering deliverables.

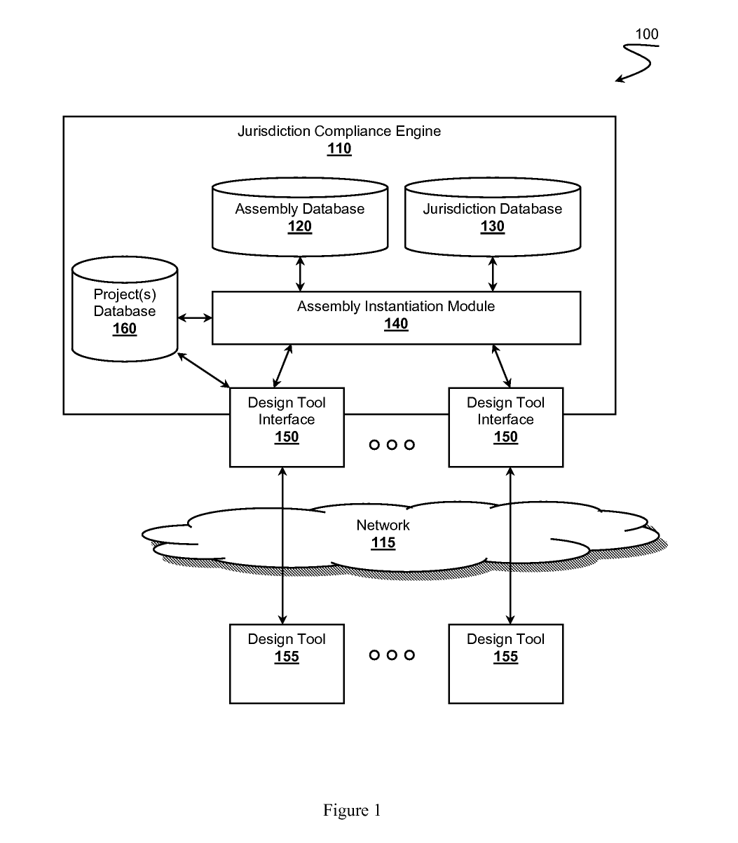

In FIG. 1, jurisdiction compliance environment 100 comprise jurisdiction compliance engine 110. Jurisdiction compliance engine 110 is communicatively coupled with one or more design tools 155 (e.g., SP3D™, OptimEyes™, PDMS™, etc.) over network 115 via one or more of design tool interface 150. Jurisdiction compliance engine 110 utilizes assembly instantiation module 140 to instantiate one or more construction objects that comply with jurisdictional rule sets when incorporated within design tools 155. In additional, compliance engine 110 can use the rule sets to provide recommendations on optimizing a project across all phases of a project's life cycle. In the example shown, compliance engine 110 has access to assembly database 120, jurisdiction database 130, or a projects database 160. Although FIG. 1 illustrates compliance engine 110 comprising the databases, it is also contemplated that the databases can be remote from compliance engine 110 and yet be accessible over network 115.

Jurisdiction compliance engine 110 can store reusable construction assembly objects in assembly database 120. A construction assembly object is generically referred to as an “assembly object” or more generically as an “assembly”. Each assembly object represents an abstracted construction object that can be instantiated in one or more design tools 155, even if design tools 155 include tools from different vendors, have different proprietary objects formats, or have other distinctions. The format of the assembly object is tool agnostic. Example construction objects include pipes, cable trays, processing units, modules, welds, aggregation of objects, inspection points, deliverables, or other types of objects associated with construction of a plant or facility. Preferably assembly database 120 stores the construction assembly objects in a design tool-agnostic format, possibly based on XML or according to a standard object description (e.g., ISO 15926, Industry Foundation Classes, Building Information Modeling, etc.). As discussed above, an assembly object is more than a mere set of parameters describing a physical object. In addition, an assembly object includes properties, contexts for which the object is available for use, behavior of the object, design rules governing the use of the object, relevant jurisdictions to which the assembly object is associated, or other types of information embodying past experiences with construction objects.

Design tools 155 can cover a broad spectrum of different types of tools. Example types of tools include Computer Aided Design (CAD) tools, modeling tools, verification tools, drafting tools, simulation tools, or other types of design tools. Design tools 155 can also include non-CAD tools. Example, non-CAD tools can include spreadsheets, project management software used to assign resources to task, process and control software, or even software development tools used to create control systems. When design tools 155 comprise non-CAD tools, corresponding assembly objects or construction objects can include Gantt charts, spreadsheets, resource lists, inspection check lists, or other types of key engineering deliverables.

As a design engineer develops a design, the design tools 155 can communicate properties of their respective modeled environment to compliance engine 110 over network 115. Based on the environments' properties, jurisdiction compliance engine 110 can derive one or more relevant project contexts related the design. Project contexts can be automatically derived, defined by a user possibly via design tool interface 150, pre-defined, or defined through a combination of techniques. The project contexts aid in selection of one or more assemblies that are available for use in the modeled environment as determined by the environment's properties. One should appreciate that each design tool 155 can have properties related to its own project context or a set of design tools 155 in aggregate can indicate an over-arching context. Compliance engine 110 identifies relevant assemblies based on the available contexts bound to the generic assembly objects. Preferably, before the relevant assemblies are instantiated as construction objects, compliance engine 110, also determines which, if any, jurisdiction rule sets are relevant to the contexts of the current project.

Jurisdiction compliance engine 110 can store jurisdiction rules sets in a jurisdiction database 130 as shown. Each rule set can also have a context for which the rule sets apply. Compliance engine 110 can determine which rule sets are relevant by examining a modeled environment's properties from design tools 155 and deriving one or more contexts related to the environment. For example, a modeled environment might have properties defining the following context based on properties obtained from design tools 155: a plant to be developed in Europe, an oil company client, the plant is an oil refinery, a construction object is a pipe, the pipe fittings must be welded, and the pipe welds must be inspected. Based on the properties, compliance engine searches for context objects matching the properties of interest. The contexts can be a priori defined or newly created. The identified contexts can be compared to a jurisdiction rule set's available contexts. In the current example, compliance engine 110 identifies multiple relevant rule sets possibly including geo-political jurisdiction requirements (i.e., Europe), corporate jurisdiction requirements (i.e., the oil company's requirements), or possibly safety requirements from the construction company or a standards body (e.g., welding requirements).

Upon selection of a relevant assemblies and jurisdiction rule sets, assembly instantiation module 140 instantiates the assembly as a specific construction object having specific parameters and values relevant to a design model of a construction project. Further, the instantiated construction object has parameters or values that conform to at least a portion of the relevant jurisdiction rule sets and behaviors associated with the assembly object. One should note instantiated construction objects can be instantiated in a tool-agnostic format, possibly stored within projects database 160 along with other current or historical project information. One instantiated, instantiation module 140 can instruct, or otherwise configure, design tools 155 to incorporate the instantiated objects into their respective models. For example, an instantiated construction object could be stored according to ISO 15926. The construction objects can be converted from such a common, intermediary format into a tool-specific format via a corresponding design tool interface 150. The construction object can be converted from ISO 15926 to the tool-specific formats, possibly based on Intergraph™ Standard File Format, DWG format used by AutoCAD™ or other tools, Geometric Description Language (GDL), or other formats. The intermediary format, or tool-specific formats, can comprises geometric parameters, code or instructions related to the functionality of the construction object, specific values, behaviors, or other properties.

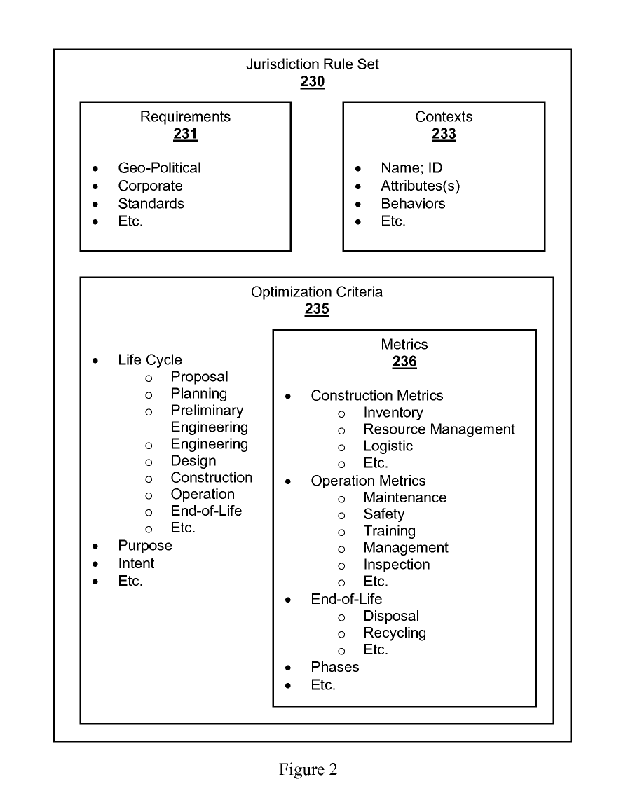

FIG. 2 presents a possible structure for a jurisdiction rule set 230. Rule set 230 comprises jurisdiction requirements 231, one or more available contexts 233, or optimization criteria 235. Jurisdiction rule set 230 represent one or more rules that are considered to be enforced by a governing entity; a government, a company, or a standards body for example. Rule set 230 comprises various types of encoded requirements 231 where the encoded requirements can be represented by instructions, code, data structures, or other types of encoding schemes. Requirements 231, or other components within rule set 230, preferably are stored within a neutral, normalized format based on XML or other types of semantic modeling techniques. Requirements 231 can take on many different forms including geo-political requirements, corporate requirements, standards, safety requirements, inspection requirements, documentation requirements, human resource requirements, or other information. Rule set 230 impacts how a construction object is instantiated or incorporated within a modeled environment. An assembly instantiation module translates requirements 231 from the generic format into a specific parameters or values of an instantiated construction object, which can further be translated to specific model parameters of a design tool by a design tool interface.

One should appreciate that jurisdiction rule set 230 exists due to a governing entity's purpose. The purpose can include nearly any facet of a construction project including safety, best practices, quality, conformity to regional standards, or other intents. A purpose can be modeled by a one or more metrics 236. For example, if safety is a goal of a jurisdiction's rules, then jurisdiction rule set 230 can include various design rules associated with safety metrics: estimated accident rates, estimated training sessions, mean-time-between-failures of components, or other safety metrics. In addition, stored jurisdiction rule set 230 can include optimization criteria 235 (i.e., design rules) that can be applied when instantiating assembly objects and that can affect estimated metrics 236 of the design. Thus, operating criteria 235 and metrics 236 provide a quantified representation of a purpose or intent of jurisdiction rule set 230.

Jurisdiction rule set 230 can take on many different forms. In some embodiments, rule set 230 comprise design tool agnostic programmatic instructions that can be applied to assemblies when instantiating the assembly as a construction object targeting a modeled environment. The instructions can be represented as a pseudo-code based on a serialized format, XML for example. The pseudo-code can then be translated to a tool-specific format for execution by the design tool via a design tool object translator. The instructions can be executed by the assembly instantiation module during instantiation of the construction object before interfacing with a design tool, or the instructions can be executed by the design tool after instantiation of the construction object. Further, in some embodiments, the design tool itself can be instructed to instantiate the construction object directly under instructions from the jurisdiction compliance engine or instantiation module. Rule set 230 can also include optimization criteria 235 by which a project can be optimized according to one or more metrics 236 relating the design, possibly based on the properties of the modeled physical environment.

Jurisdiction rule set 230, as discussed previously, can comprise optimization criteria 235 reflecting a possible purpose or intent of rule set 230. For example, a federal jurisdiction might include multiple rule sets for different purposes. Some rule sets might reflect federal safety standards while other rule sets might reflect preferred types of bidders for contracts. Optimization criteria 235 provide a quantified representation how well a construction project, or a portion of a project, adheres to the purpose of rule set 230. Purpose or intent can be further quantified via corresponding metric 236, which can be measured from an analysis of the design model across one or more design tools by exchanging design parameters with the compliance engine. The compliance engine calculates metrics 236 as a function the design parameters or other information according to the optimization criteria 235. The compliance engine's assembly insanitation module can instantiate a metric object from metrics 236 and instruct the design tools to present the metric values to a design engineer.

Rule set 230 can have more then one type of optimization criteria 235. For example, optimization criteria 235 can include life-cycle criteria targeting one or more phases of a construction project. Example criteria can focus on construction phases representing a proposal stage, a planning stage, a design stage, an engineering stage, a procurement stage, a construction stage, an operation stage, a management stage, or an end-of-life stage. Further, metrics 235 can comprises values reflecting individual stages or combined stages as illustrated.

Rule set 230 preferably comprises one or more of available contexts 233. Contexts 233 reference scenarios or circumstances under which rule set 230 would likely be relevant. Context 233 includes one or more attributes, parameter-value pairs for example, defining the context. Context 233 can be treated as a context object linked to rule set 230 where the context object has an identifier, relevant behaviors, or other properties related to a scenario. For example, a processing plant in the Middle East would likely have attributes related to a region, climate, safety standards, or other information. The compliance engine can search through its jurisdiction database seeking one or more rule sets 230 having contexts 233 with similar attributes thus indicating the corresponding rule sets 230 could be relevant to a design model, as least to within a satisfaction level of a context selection criteria.

Upon obtaining relevant jurisdiction rule sets 230, the jurisdiction engine can communicate with one or more assembly instantiation modules where an instantiation module instantiates a construction object from an assembly according the identified jurisdiction rule sets 230. The instantiation module can convert the instantiated construction object to a preferred format of a target design tool. One should appreciate that instantiation of the construction object can include converting to a desired format as well as providing instructions directly to the design tool, possibly via an API, so that the object is automatically integrated into the tool's modeled environment. Further, a single construction object can be incorporate into a multiple, distinct tools as required. In such embodiments, each tool can have a different form of the construction object. For example, a 3D design tool would likely incorporate a 3D modeled object while a spreadsheet design tool would incorporate specific details for the construction object (e.g., catalog number, dimensions, cost, etc.), possibly as a bill-of-materials.

One should appreciate that the disclosed jurisdiction compliance engine operates in real-time with the design engineer. As the design engineer, or multiple design engineers, effect changes in the modeled environment, the design tools can exchange notifications with the jurisdiction engine, possibly via a locally installed monitoring agent within the design tool. The jurisdiction engine can monitor how instantiated assemblies are used within the modeled environment to determine if one or more requirement in a jurisdiction rule set is out of compliance. Thus the jurisdiction engine seeks to validate a 3D design with respect to jurisdiction rule sets or other design practices in real-time.

Consider placement of an in-line flow instrument, and orifice plate for example, to measure flow rates. The in-line flow instrument likely requires a minimum upstream and downstream straight length so that it can make proper measurements. As the design engineer places an instantiated version of the instrument in a 3D model, the jurisdiction engine can check that that the upstream and downstream lengths are considered in compliance according the instrument's jurisdiction requirements. If the upstream and downstream lengths are out of compliance, the jurisdiction engine can generate one or more recommendations for corrective actions, possibly including creating a new instantiation of the violating upstream and downstream lengths.

Although the above example is presented with respect to modeled aspects of the design, one should appreciate the same approach can be applied to non-design related activities. For example, if the lengths require adjustment, the engine can also adjust estimated material quantities, inventory logs, resource management plans, training material, inspection point check lists, logistic plans, or other types of engineering deliverables. One should appreciate that changes to a design can affect key engineering deliverables required by a jurisdiction. As indicated estimated plans, logistic plans, material manifests, or other documentation can also be affected. Therefore, the jurisdiction can also provide input or recommendations on how to converge on stable key engineering deliverables.

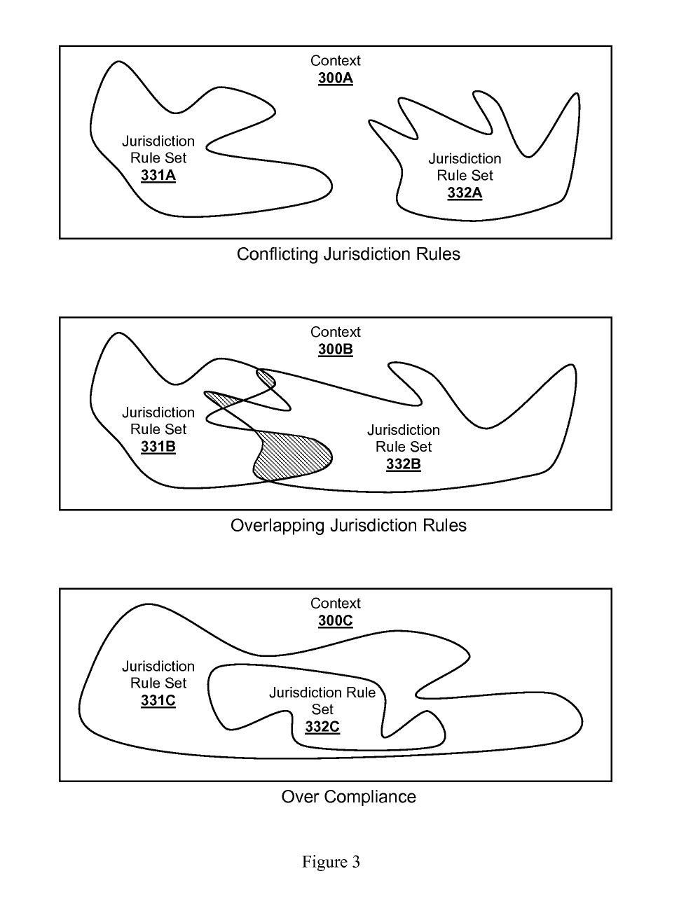

FIG. 3 illustrates possible conditions where jurisdiction rule sets 331 and 332 interact with respect to contexts 300. A jurisdiction compliance engine derives context 300A, 300B, and 300C, collectively referred to as contexts 300, from one or more design tools. With respect to context 300A, the compliance engine determines that jurisdiction rule sets 331A and 332A are considered relevant to context 300A. In this example, rule sets 331A and 332A are in conflict because each rule set includes requirements or rules that do not over lap. In such a scenario, the compliance engine can notify the design engineer of the conflict. The design engineer, via one or more design tool interfaces, can select which jurisdiction rules 331A or 332B should have precedence. One should appreciate that conflicting rule sets 331A and 332B might be in conflict with respect to covering a context, but might not be in conflict with respect to an instantiated construction object. For example, two welding rule sets might be in conflict with respect to a stainless steel pipe, but might not be in conflict if the pipe comprises other materials.

In the example of context 300B, jurisdiction rule sets 331B and 332B have some level of compatibility because they rule sets have overlapping coverage as indicated with respect to the shaded regions. In embodiments, where rule sets 331B and 332B have compatible requirements, the design engineer is notified to ensure instantiated construction objects comprise parameters that stay in compliance with both rule sets 331B and 332B.

As a modeled design changes in real-time, the instantiation module or other agent, possibly local to a design tool, can monitor the changes made in a single design tool or a set of design tools. In some embodiments, the instantiation module automatically or continuously monitors changes to contexts 300B, or other contexts, to determine how compliancy also changes. When a change has taken place that could affect compliance, the instantiation module can also instruct the design tool to update an instantiated construction object, in real-time, based on selected rule sets and the changes detected in the context 300B.

In view that multiple jurisdiction rule sets 331 and 332 can be considered relevant to an assembly or context, one should appreciate that the rule sets 331 and 332 could interfere with each other. The interference does not necessarily require that an instantiated construction object is out of compliance with one rule set over another as reference above. Rather, an instantiated construction object could be in compliance with more than one rule set, where the construction object can be considered to be in “over compliance” with one rule set relative to another as illustrated in context 300C. For example, the instantiated object might comply with both jurisdictional requirements of two regions (e.g., city, county state, country, corporation, client, etc.), but one region has stricter compliance than another as indicated by rule sets 332C relative to 331C. Perhaps, compliance in one country has more strict compliance regulations than another country. If an instantiated construction object is determined to overly comply with a rule set 331C relative to a second rule set 332C, then the engine can notify the design tool of the over compliance.

One should appreciate that detected differences in compliance between rule sets 331 and 332 are potential opportunities for optimization. When an instantiated construction object is found to be in over compliance within a context 300, the jurisdiction compliance engine can recommend a jurisdiction optimization for the instantiated construction object where the recommendation reflects a possible design optimization. The optimization can be characterized relative to a metric associated with the jurisdiction or to the project in general as discussed previously. A recommendation can take the form of a proposed newly instantiated construction object that is considered to improve one or more metrics while still being in compliance with a least common denominator jurisdiction rule set 332C. The recommendation can be presented via a design tool interface where a set of instantiated construction objects are presented according to a ranking determined by compliance with one or more of the rule sets, calculated metrics, or other ranking criteria.

Still, jurisdiction rule sets could be in conflict with each other causing an exception to be raised as in context 300A. The exception can be raised through the compliance engine, through the design tool interface, then on to the design engineer as desired. The exception, or other notification, can include further recommended design changes for the instantiated construction objects to reduce non-compliancy. The design changes indicate how the instantiated construction object can be changed to bring it into compliance with rule set 331A or 332A. One should note that the exception could be raised for objects other than the instantiated object.

As noted above, a project can be optimized based on jurisdictional information obtained from jurisdiction rule sets 331 or 332, preferably based on a purpose of the rule set. It is also contemplated that the rule sets can comprise project life-cycle optimization criteria with respect to one or more metrics. Project life-cycle optimization criteria can include various rules by which a project can be optimized according to different phases of the project from conception, design, engineering, procurement, construction, operation, management, or even end-of-life. Such optimization criteria can be based on a jurisdiction's purpose for establishing a set of design practices. For example, a corporate jurisdiction rule set might reflect optimization criteria minimizing logistics, while a geo-political jurisdiction rule set might reflect optimization criteria for maximizing safety. Naturally, the two optimizations criteria can likely coexist. However, it is possible they could be in conflict with each other.

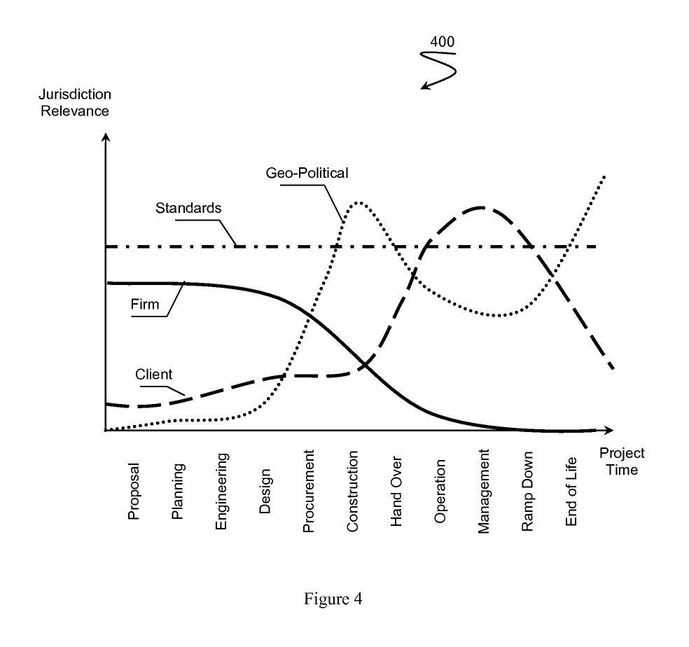

FIG. 4 presents qualitative graph 400 illustrating relevance of different jurisdiction rule sets with respect to project phase. One should appreciate the graph 400 is presented for illustrative purposes to show how each jurisdiction could have high relevance, or even precedence, relative to each other with respect to project phases or time. For example, early in the construction project jurisdictions associated with standards body or a construction firm might have more relevance or take precedence over jurisdictions associated with a client or a geo-political jurisdiction. Later in the construction project, possibly during construction, the geo-political jurisdiction could override other jurisdictions. At a later stage in a construction project, possibly near end-of-life, the geo-political jurisdiction might again take precedence.

Each jurisdiction rule set can include information associated with its precedence for each phase of a construction project. When assemblies are instantiated as construction objects, the construction objects can also inherit such precedence. The design tools incorporate the construction object and can indicate how the construction object relates to the jurisdictions as a function of construction object life cycle or jurisdiction rule set precedence.

As an example, consider project life-cycle optimization criteria can include operational optimization criteria reflecting operation activities as well as early design optimization criteria. Operational optimization criteria can include rules that cause an assembly object to be instantiated in a manner to optimize various metrics including maintenance metric, a safety metric, a training metric, or a operation metric. Even though the design engineer works on an early phase of the project, design phase or engineering stage, the design engineer can see how the instantiated construction objects relates to relevant jurisdictions later in the project. Thus, the design engineer can affect changes early in a construction object when changes are less costly. As a more specific example, a jurisdiction rule sets could allow for use of many different valves assemblies. The rule set could also include operational optimization criteria that attempts to minimize maintenance time during operation of a facility. Therefore, the compliance engine could recommend a valve having reduced maintenance costs to reduce an estimated maintenance metric with respect to a client's jurisdiction rule set.

Still further, project life-cycle optimization criteria can extend beyond construction or operational optimization criteria. As an example of criteria other than construction or operational criteria, considered end-of-life criteria. When the jurisdiction compliance engine makes a recommendation, the recommendation can reflect an attempt to alter an estimated end-of-life metric by updating an instantiated construction object. Example end-of-life metrics can include disposal metrics or even recycling metrics. For example, the jurisdiction rule set can include rules for ensuring materials used in the design can be recycled. When an assembly object is instantiated to comply with the jurisdiction rule set, the engine can make recommendations as to which type of material should be used for construction component to optimization the recycling metric or disposal metric, where a one type of material might be more easily recycled or disposed of relative to another type of material.

Jurisdiction rule sets are considered living objects that can change with time over a life time of a construction project, especially in view that a construction project can exist for decades. As time passes jurisdiction rule sets can also change in scope, become obsolete, come into being, or otherwise change with time. Upon a change in a jurisdiction rule sets, the compliance engine can consult a projects database (see FIG. 1, projects database 160) of current or previous construction projects to determine if the historical projects would be affected by the change. Further, the compliance engine can, in real-time, monitor a current project design to determine if one or more portions of the design should be updated according to the changes in the jurisdiction rule sets.

One should appreciate that instantiated construction objects can also represent key engineering deliverables for a construction project beyond a design module. Other deliverables can include drawings, specifications, training manuals, Gantt charts, test or inspection plans, logistic schedules, check lists, construction schedules, bill of materials, or other types of construction objects.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A jurisdiction compliance engine for instantiating construction objects, the engine comprising:
a construction assembly database storing reusable construction assembly objects;
a jurisdiction database storing jurisdiction rule sets, the jurisdiction rule sets having jurisdiction contexts;
a design tool interface configured to communicatively couple to a design tool and to provide access to the construction and jurisdiction databases; and
an assembly instantiation module configured to select automatically at least one jurisdiction rules as a function of a project context obtained via the design tool interface, or project pre-defined context criteria, and to instruct the design tool, via the design tool interface, to instantiate an assembly as a construction object from the assembly database according to the at least one selected jurisdiction rule set obtained from the jurisdiction database.

2. The engine of claim 1, wherein the at least one jurisdiction rule set codifies geo-political jurisdiction requirements for a construction object.

3. The engine of claim 1, wherein the at least one jurisdiction rule set codifies corporate jurisdiction requirements for construction object design.

4. The engine of claim 1, wherein the at least one jurisdiction rule set includes at least a first and a second, different jurisdiction rule set.

5. The engine of claim 4, wherein the assembly instantiation module is further configured to notify the design tool when an instantiated construction object overly complies with the first rule set relative the second rule set.

6. The engine of claim 5, wherein the assembly instantiation module is further configured to recommend a jurisdiction optimization for the instantiated construction object within a jurisdiction corresponding with the first rule set.

7. The engine of claim 4, wherein the assembly instantiation module is further configured to notify the design tool of a conflict in compliance between the first rule set and the second rule set.

8. The engine of claim 7, wherein the assembly instantiation module is further configured to recommend a design change for the instantiated construction object to bring the instantiated assembly into compliance with at least one of the first or the second rule set.

9. The engine of claim 1, wherein the at least one jurisdiction rule set comprises a project life-cycle optimization criteria.

10. The engine of claim 9, wherein the project life-cycle optimization criteria comprises construction optimization criteria.

11. The engine of claim 10, wherein the construction optimization criteria includes rules for optimizing at least one of an inventory metric, a resource management metric, and a logistic metric.

12. The engine of claim 9, wherein the project life-cycle optimization criteria comprises operation optimization criteria.

13. The engine of claim 12, wherein the operation optimization criteria includes rules for optimizing at least one of an maintenance metric, a safety metric, a training metric, and a management metric.

14. The engine of claim 9, wherein the project life-cycle optimization criteria comprises end-of-life optimization criteria.

15. The engine of claim 14, wherein the end-of-life optimization criteria includes rules for optimizing at least one of a disposal metric, and a recycling metric.

16. The engine of claim 1, wherein the design tool interface is configured to allow the design tool to select the construction object.

17. The engine of claim 1, wherein the design tool interface is configured to allow a design engineer to select the at least one jurisdiction rule set.

18. The engine of claim 1, wherein the assembly objects are stored within the assembly database in a design tool agnostic format.

19. The engine of claim 1, wherein the jurisdiction rule sets are stored within the jurisdiction database in a design tool agnostic format.

20. The engine of claim 1, wherein the assembly instantiation module is further configured to instruct the design tool to update the instantiated construction object in real-time as a function of the at least one jurisdiction rule set and changes to a design obtained via the design tool interface.
